(19) United States
(12) Patent Application Publication
(10) Pub. No.: US 2022/0091727 A1
(43) Pub. Date: Mar. 24, 2022

(54) DISPLAY CONTROL DEVICE AND DISPLAY CONTROL PROGRAM

(71) Applicant: SEIKO EPSON CORPORATION, Tokyo (JP)

(72) Inventor: Hiroyuki TOKUNAGA, Matsumoto (JP)

(21) Appl. No.: 17/480,205

(22) Filed: Sep. 21, 2021

(30) Foreign Application Priority Data
Sep. 23, 2020 (JP) 2020-158894

(51) Int. Cl. G06F 3/0481; G06F 3/0484

(52) U.S. Cl. CPC G06F 3/04817; G06F 3/04847

(57) ABSTRACT

A display control device that causes a display section to display a button includes a display control section configured to cause the display section to display notification to the effect that the button is operated and an execution control section configured to cause a device to execute a function corresponding to the operated button. The display control section causes the display section to display the notification in a form corresponding to the distance between a display position of the operated button and a display position of the notification.

The present application is based on, and claims priority from JP Application Serial Number 2020-158894, filed Sep. 23, 2020, the disclosure of which is hereby incorporated by reference herein in its entirety.

### BACKGROUND

### 1. Technical Field

The present disclosure relates to a display control device and a display control program.

### 2. Related Art

A plurality of buttons for setting functions of a device are displayed on a display, whereby an operable user interface (hereinafter, UI) screen is provided to a user. For example, there has been disclosed a printing apparatus including a touch panel-type display and a control section that causes the display to display setting items concerning printing and printing start instruction buttons in forms corresponding to setting contents set in the setting items (see JP-A-2017-130776 (Patent Literature 1)).

On such a UI screen, when the user operates some button by touching or clicking the button, visual information such as a specific icon, illustration, or animation is temporarily changed according to the operation to clearly inform a result of the operation to the user. Such processing for temporarily changing the visual information and clearly informing the result of the operation to the user is referred to as micro-interaction as well.

The user operating a button displayed on the UI screen views the button to be operated by the user and the periphery of the button. Accordingly, when the distance between the operated button and a position where the micro-interaction or notification similar to the micro-interaction is displayed is long, in some case, the user less easily notices the notification and less easily understands what kind of setting is performed by the operation by the user. Conversely, when the distance between the operated button and the position where the micro-interaction or the notification similar to the micro-interaction is displayed is short, if a form of the notification is exaggerated, it is likely that the user feels unpleasant.

### SUMMARY

A display control device that causes a display section to display a button for setting a function of a device includes: a display control section configured to cause, according to operation of the button, the display section to display notification to the effect that the function corresponding to the operated button is set; and an execution control section configured to cause the device to execute the function corresponding to the operated button. When a distance between a display position of the operated button and a display position of the notification is a first distance, the display control section causes the display section to display the notification in a more conspicuous form than when the distance between the display position of the operated button and the display position of the notification is a second distance shorter than the first distance.

A non-transitory computer-readable storage medium stores a display control program for causing a processor to execute processing for displaying, on a display section, a button for setting a function of a device, the display control program including: a display control function for causing, according to operation of the button, the display section to display notification to the effect that the function corresponding to the operated button is set; and an execution control function for causing the device to execute the function corresponding to the operated button. When a distance between a display position of the operated button and a display position of the notification is a first distance, the display control function causes the display section to display the notification in a more conspicuous form than when the distance between the display position of the operated button and the display position of the notification is a second distance shorter than the first distance.

### BRIEF DESCRIPTION OF THE DRAWINGS

FIG. 1 is a block diagram schematically showing a system.

FIG. 2A is a diagram showing an example of a UI screen.

FIG. 2B is a diagram showing an example of the UI screen after scrolling operation.

FIG. 3 is a flowchart showing display control processing according to a first embodiment.

FIG. 4A is a diagram showing an example of a setting image.

FIG. 4B is a diagram showing another example of the setting image.

FIG. 5A is a diagram showing an example of a UI screen in a simple display mode.

FIG. 5B is a diagram showing an example of the UI screen after customizing operation.

FIG. 6 is a diagram showing an example of a vertically long UI screen.

FIG. 7 is a flowchart showing display control processing according to a second embodiment.

FIG. 8A is a diagram showing an example of a positional relation between a display section and a camera.

FIG. 8B is a diagram showing an example of a UI screen on which a guidance display is performed.

FIG. 9 is a diagram showing a correspondence relation between a distance and a conspicuousness level.

### DESCRIPTION OF EXEMPLARY EMBODIMENTS

An embodiment of the present disclosure is explained below with reference to the figures. The figures are only illustrations for explaining this embodiment. Since the figures are the illustrations, in some case, ratios and shapes are inaccurate, the figures are inconsistent with one another, or a part of the figures are omitted.

### 1. Overview of a Device Configuration

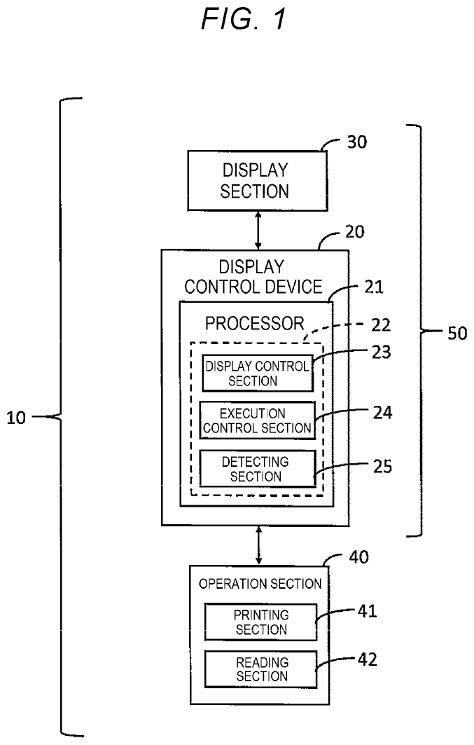

FIG. 1 schematically shows a configuration of a system 10 according to this embodiment using a block diagram. The system 10 includes a display control device 20, a display section 30, and an operation section 40 communicably coupled to one another. The display control device 20 includes a processor 21 including a CPU. The processor 21 functions as a display control section 23, an execution control section 24, a detecting section 25, and the like according to a program 22 and data stored in a predetermined memory. At least a part of the program 22 corresponds to a display control program. The detecting section 25 is a component necessary for, of a first embodiment and a second embodiment explained below, the second embodiment.

The display control device 20 causes the display section 30 to display buttons for setting functions of a device (hereinafter, setting buttons). The display section 30 is configured using, for example, a liquid crystal panel on which a touch panel is laid. The display section 30 receives operation of a user such as touch and click. The display section 30 may be understood as a part of components of the display control device 20 or may be understood as a peripheral device of the display control device 20. A component including the display control device 20 and the display section 30 may be referred to as display device 50. The display control device 20 or the display device 50 is, for example, a smartphone, a tablet terminal, a personal computer (PC), or a projector. In this embodiment, the display section 30 also functions as a receiving section that receives operation by the user. However, the display section and the receiving section may be separately provided.

The operation section 40 executes a predetermined operation under control by the processor 21. The operation section 40 includes, for example, a printing section 41 and performs printing on a printing medium with the printing section 41. The operation section 40 includes, for example, a reading section 42 and performs reading of a document with the reading section 42. Such an operation section 40 corresponds to the device explained above and is, in an example shown in FIG. 1, a multifunction peripheral functioning as a printer and a scanner. Naturally, the operation section 40 may be a device including only one of the printing section 41 and the reading section 42. The operation section 40 is not limited to the printer and the scanner and can correspond to various devices such as a projector and a facsimile.

The entire system 10 may be understood as one device 10. That is, the device 10 may be understood as an operation panel for the operation section 40 of the device 10 to execute printing and reading and for the display section 30 of the device 10 to receive operation from a user.

### 2. First Embodiment

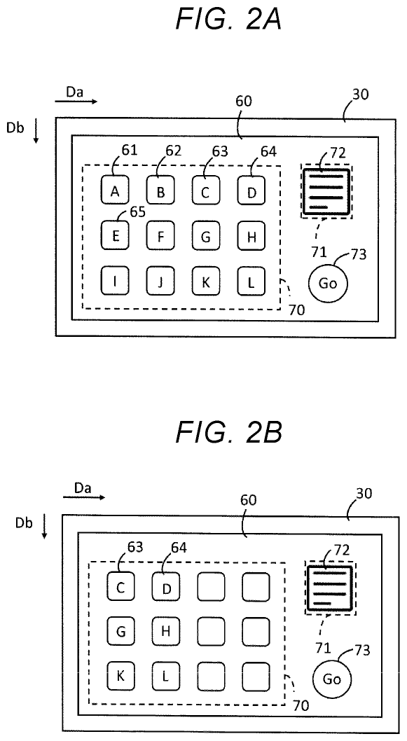

FIG. 2A shows an example of a UI screen 60 that the display control section 23 causes the display section 30 to display. The UI screen 60 is, for example, a screen for setting functions of the reading section 42. On the UI screen 60, a plurality of setting buttons 61, 62, 63, 64, 65, . . . are displayed side by side in a lateral direction Da and a longitudinal direction db of the screen. In FIG. 2A, the setting buttons are extremely simply shown. For example, the setting button 63 marked “C” is a button for setting both-side scan function of the reading section 42. The setting buttons 61, 62, 64, 65, . . . are buttons for setting various functions of the reading section 42 such as monochrome scan, color scan, one-side scan, scan quality, and a saving method for scan data. Naturally, the UI screen 60 may be a UI screen for setting functions of the printing section 41.

As indicated by a frame of a broken line in FIG. 2A, the setting buttons are disposed in a button display region 70 in the UI screen 60. Broken lines indicating the button display region 70 and a notification display position 71 explained below may not be actually displayed in the UI screen 60. In a predetermined notification display position 71 secured separately from the button display region 70 in the UI screen 60, “notification” to the effect that a function corresponding to a setting button operated by the user is set is displayed. Such notification is hereinafter referred to as “setting image 72”. Changing and displaying the setting image 72 according to a change of setting may be understood as a kind of micro-interaction.

As it is seen from FIG. 2A, the notification display position 71 is a region having a certain degree of an area. Further, in the UI screen 60, an operation start button 73 for the user to cause the operation section 40 to execute operations such as reading and printing is displayed.

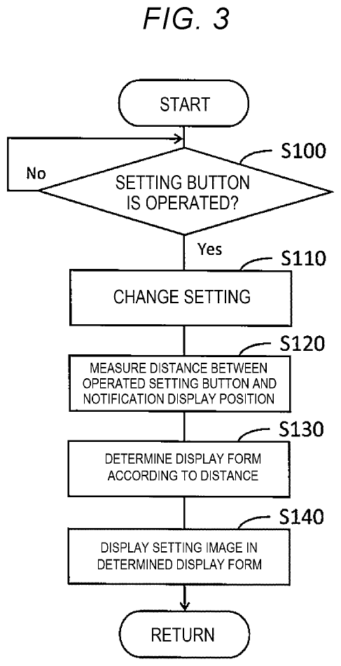

FIG. 3 shows display control processing according to the first embodiment as a flowchart.

The processor 21 executes the flowchart in a situation in which the processor 21 is causing the display section 30 to display the UI screen 60. The display control section 23 continuously determines whether any one of the setting buttons in the UI screen 60 is operated (step S100). When detecting that any one of the setting buttons in the UI screen 60 is operated, the display control section 23 determines “Yes” in step S100 and proceeds to step S110.

In step S110, the execution control section 24 changes setting concerning the operation section 40 according to the setting button determined in step S100 as being operated. As an example, it is assumed that, on the UI screen 60 shown in FIG. 2A, the user touches the setting button 63 marked “C”. As explained above, the setting button 63 is a button for setting the both-side scan function of the reading section 42. Accordingly, in step S110, the execution control section 24 changes a part of present setting stored concerning the reading section 42 to both-side scan. More specifically, the execution control section 24 changes setting for the one-side scan to setting for the both-side scan.

Subsequently to step S110, in step S120, the display control section 23 measures the distance between a display position of the operated setting button and the notification display position 71 in the UI screen 60. The display control section 23 only has to measure, for example, the distance between the center of the operated setting button and the center of the notification display position 71. The processor 21 may carry out step S110 and step S120 in parallel.

In step S130, the display control section 23 determines a display form of the setting image 72 according to the distance measured in step S120. Basically, the display control section 23 determines the display form of the setting image 72 to be a more conspicuous form as the measured distance is longer.

In step S140, the display control section 23 causes the display section 30 to display the setting image 72 corresponding to the operated setting button in the notification display position 71 of the UI screen 60 in the display form determined in step S130.

The processor 21 only has to repeatedly execute the flowchart of FIG. 3 until the operation start button 73 is operated in a situation in which the processor 21 is causing the display section 30 to display the UI screen 60.

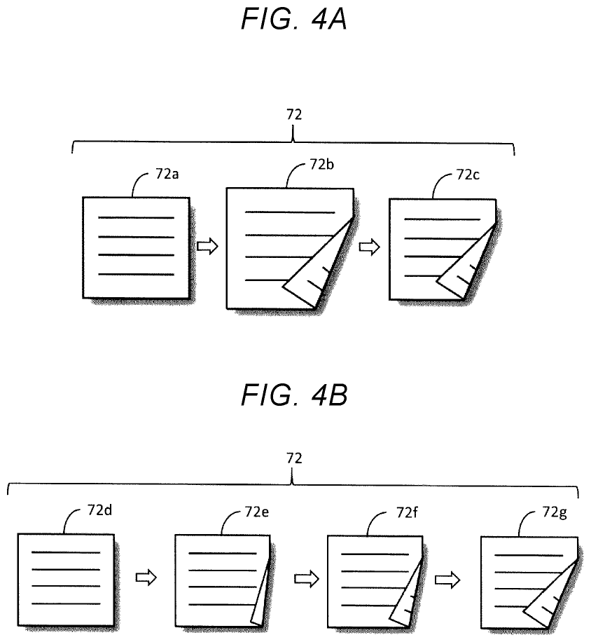

FIG. 4A shows an example of the setting image 72 displayed in the notification display position 71 in step S140. The setting image 72 shown in FIG. 4A is a setting image displayed in the notification display position 71 according to operation of the setting button 63. The setting image 72 notifies the user that the setting of the one-side scan is changed to the setting of the both-side scan concerning the reading section 42. As shown in FIG. 4A, images 72a, 72b, and 72c, which are illustrations simply representing documents, are displayed in the notification display position 71 in this order.

The image 72a is an illustration representing the one-side scan. The images 72a and 72c of states in which parts of documents are turned up are illustrations representing the both-side scan. That is, the display control section 23 transitions the display in the notification display position 71 to the image 72a, the image 72b and the image 72c within a predetermined period, for example, one second to thereby cause the user to recognize that the setting is changed from the one-side scan to the both-side scan.

As it is seen from FIG. 4A, the image 72b displayed at timing between the image 72a and the image 72c has a larger size than the images 72a and 72c before and after the image 72b. The display control section 23 increases the size of the image 72b halfway in such transition to attract attention of the user for the setting image 72 and allow the user to easily understand a result of operation that the user optionally performed.

As explained above, the display control section 23 determines the display form of the setting image 72 to be a more conspicuous form in step S140 as the distance measured in step S120 is longer. This can be considered to mean that, when the distance between the display position of the operated setting button and the notification display position 71 is a first distance, the display control section 23 displays the setting image 72 in a more conspicuous form than when the distance between the display position of the operated setting button and the notification display position 71 is a second position shorter than the first distance. The setting image 72 involves some change during a display period. In the example shown in FIG. 4A, the display of the setting image 72 temporarily increases in size. Therefore, “determining the display form of the setting image 72 to be a more conspicuous form” means that, referring to FIG. 4A, a size ratio of the image 72b to the images 72a and 72c is further increased.

A comparison is made between when the setting button 63 is displayed in the position shown in FIG. 2A and when the same setting button 63 is provisionally displayed in the position of the setting button 61 in FIG. 2A. When displaying the setting image 72 in the notification display position 71 according to touch of the setting button 63, the display control section 23 displays the image 72b in a larger size when the display control section 23 displays the setting button 63 in the position of the setting button 61 in FIG. 2A. That is, the distance between the setting button 63 and the notification display position 71 at the time when the setting button 63 in the position shown in FIG. 2A is touched is an example of the second distance. The distance between the setting button 63 and the notification display position 71 at the time when the setting button 63 displayed in the position of the setting button 61 in FIG. 2A is touched is an example of the first distance. In this embodiment, the “first distance” and the “second distance” do not respectively indicate specific distances and are only names for distinguishing different two distances. Of the different two distances, a relatively long distance is referred to as first distance and a relatively short distance is referred to as second distance.

The change of the setting image 72 for attracting attention of the user is not limited to the change of the size and includes various changes such as a change of a position, a change of a color, a change of brightness, and a change of a pattern. As the change of the position, swing, rotation, and the like of the setting image 72 in the notification display position 71 are assumed. Therefore, as “determining the display form of the setting image 72 to be a more conspicuous form”, besides increasing the size change, there are various methods such as making the change of the position larger, making the change of the color more colorful, making the change of the brightness more intense, and making the change of the pattern larger. Besides, further increasing the number of times of the change of the setting image 72 and further extending a time of the change of the setting image 72 also correspond to “determining the display form of the setting image 72 to be a more conspicuous form”.

FIG. 4B shows an example different from the example shown in FIG. 4A of the setting image 72 displayed in the notification display position 71 in step S140. Like the setting image 72 shown in FIG. 4A, the setting image 72 shown in FIG. 4B is a setting image displayed in the notification display position 71 according to operation of the setting button 63. As shown in FIG. 4B, an image 72d is an illustration representing the one-side scan and images 72e, 72f, and 72g of states in which parts of documents are turned up are illustrations representing the both-side scan. The display control section 23 transitions the display in the notification display position 71 to the image 72d, the image 72e, the image 72f, and the image 72g within a predetermined period to thereby cause the user to recognize that the setting is changed from the one-side scan to the both-side scan.

As it is seen from FIG. 4B, the turned-up parts of the documents gradually increase in size in the illustrations of the images 72e, 72f, and 72g in this order. The display control section 23 displays the setting image 72 including the turned-up parts of the documents gradually increasing in size in this way to attract attention of the user and allow the user to easily understand a result of operation that the user optionally performed.

When it is assumed that the setting image 72 shown in FIG. 4B is displayed in the notification display position 71 according to touch of the setting button 63, the display control section 23 displays the setting image 72 more conspicuously as the distance measured in step S120 is longer. For example, the display control section 23 repeats processing for transitioning the display in the notification display position 71 to the image 72d, the image 72e, the image 72f, and the image 72g a larger number of times as the distance is longer.

In response to the operation of the operation start button 73, the execution control section 24 causes the operation section 40 to execute functions corresponding to the setting buttons operated to that point. For example, when the both-side scan and the color scan are set about the reading section 42 by operation for the UI screen 60 for setting functions of the reading section 42, in response to the operation of the operation start button 73, the execution control section 24 causes the reading section 42 to execute the color scan targeting both sides of a document. For example, when a magnification ratio of 150% and monochrome printing are set about the printing section 41 by operation for the UI screen 60 for setting functions of the printing section 41, in response to the operation of the operation start button 73, the execution control section 24 causes the printing section 41 to execute the monochrome printing at the magnification ratio of 150%.

The disposition of the setting buttons in the UI screen 60 is not always fixed. As explained in examples below, the display control section 23 can change the distance between a display position of each of the setting buttons and the notification display position 71 according to predetermined operation by the user. The display control section 23 differentiates a display form of the setting image 72 according to the distance between the display position of the operated setting button and the notification display position 71.

FIG. 2B shows an example of the UI screen 60 in a state different from FIG. 2A. Concerning FIG. 2B, explanation is omitted about matters common to FIG. 2A. The display control section 23 scrolls display in the button display region 70 according to scrolling operation for the button display region 70 by the user. FIG. 2B shows the button display region 70 after the display is scrolled by, for example, the user swiping a finger in parallel to the lateral direction Da in the button display region 70 shown in FIG. 2A. Consequently, the distance to the notification display position 71 changes for each of the setting buttons.

When the button display region 70 shown in FIG. 2B and the button display region 70 shown in FIG. 2A are compared, in FIG. 2B, the disposition of the setting buttons in the button display region 70 moves in the left direction as a whole, a part of the setting buttons displayed in FIG. 2A disappear from the button display region 70, and a part of the setting buttons not displayed in FIG. 2A are displayed in the button display region 70. When FIG. 2A and FIG. 2B are compared, for example, the setting button 63 is farther away from the notification display position 71 in the display position in FIG. 2B than in the display position in FIG. 2A. Therefore, the distance between the display position of the setting button 63 and the notification display position 71 in FIG. 2B and the distance between the display position of the setting button 63 and the notification display position 71 in FIG. 2A correspond to a set of the first distance and the second distance. Based on the above explanation, when the setting button 63 is operated in the state shown in FIG. 2B, the display control section 23 displays the setting image 72 corresponding to the setting button 63 in a more conspicuous form than when the setting button 63 is operated in the state shown in FIG. 2A.

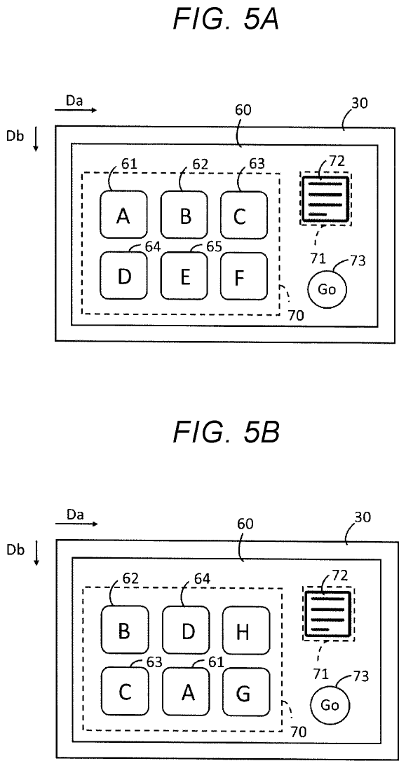

FIG. 5A shows an example of the UI screen 60 in a state different from FIGS. 2A and 2B. Concerning FIG. 5A, explanation is omitted about matters common to FIGS. 2A and 2B. The display control section 23 has several display modes concerning design of the UI screen 60. Among the display modes, there are a normal display mode and a simple display mode. The simple display mode is a display mode for reducing the number of setting buttons displayed on the display section 30 at a time than the number of setting buttons in the normal display mode and increasing a size per one setting button to improve visibility.

It is assumed that the UI screen 60 shown in FIGS. 2A and 2B is display by the normal display mode. The UI screen 60 shown in FIG. 5A and FIG. 5B referred to below is display by the simple display mode. According to the examples shown in the figures, in the normal display mode, twelve setting buttons are displayed in the button display region 70 at a time and, in the simple display mode, six setting buttons are displayed in the button display region 70 at a time. The user can change the normal display mode to the simple display mode and change the simple display mode to the normal display mode by optionally operating the UI screen 60. The display control section 23 changes, according to such changing operation for the display modes, display positions and sizes in the button display region 70 about the setting buttons. As a result, as it is seen from the comparison of FIG. 2A and FIG. 5A, the distance to the notification display position 71 is changed for each of the setting buttons.

When FIG. 2A and FIG. 5A are compared, for example, the setting button 64 marked “D” is farther away from the notification display position 71 in the display position in FIG. 5A than the display position in FIG. 2A. Therefore, the distance between the display position of the setting button 64 and the notification display position 71 in FIG. 5A and the distance between the display position of the setting button 64 and the notification display position 71 in FIG. 2A correspond to the set of the first distance and the second distance. As explained above, when the setting button 64 is operated in the state shown in FIG. 5A, the display control section 23 displays the setting image 72 corresponding to the setting button 64 in a more conspicuous form than when the setting button 64 is operated in the state shown in FIG. 2A.

FIG. 5B shows an example of the UI screen 60 in a state different from FIGS. 2A, 2B, and 5A. Concerning FIG. 5B, explanation is omitted about matters common to FIGS. 2A, 2B, and 5A. The user can select, by optionally operating the UI screen 60, a setting button to be displayed on the display section 30. That is, the user can freely customize, considering a usual frequency of use and easiness of use, setting buttons and positions where the setting buttons are displayed. The display control section 23 changes, according to such customizing operation, display positions in the button display regions 70 about the setting buttons. The UI screen 60 shown in FIG. 5B shows a state after the customizing operation is performed for the UI screen 60 shown in FIG. 5A. As it is seen from comparison of FIG. 5A and FIG. 5B, the distance to the notification display position 71 is changed for each of the setting buttons by the customizing operation. A part of the setting buttons are replaced. It goes without saying that the display control section 23 is capable of receiving the customizing operation by the user in the normal display mode as well.

When FIG. 5A and FIG. 5B are compared, for example, the setting button 63 is farther away from the notification display position 71 in the display position in FIG. 5B than in the display position in FIG. 5A. Therefore, the distance between the display position of the setting button 63 and the notification display position 71 in FIG. 5B and the distance between the display position of the setting button 63 and the notification display position 71 in FIG. 5A corresponds to the set of the first distance and the second distance. Based on the above explanation, when the setting button 63 is operated in the state shown in FIG. 5B, the display control section 23 displays the setting image 72 corresponding to the setting button 63 in a more conspicuous form than when the setting button 63 is operated in the state shown in FIG. 5A.

The user can optionally change the size of the UI screen 60. In this embodiment, it is assumed that the change of the screen size includes a change of an aspect ratio of a screen as well in meaning. The user can set the UI screen 60 to a longitudinally long size or a laterally long size by, for example, changing the direction of the smartphone or the tablet terminal including the display section 30 to a longitudinal direction or a lateral direction. The user can optionally change, within a full size of a screen of the display section 30 itself, the size of the UI screen 60 displayed on the display section 30 functioning as a display of the PC. The display control section 23 changes the display positions of the setting buttons according to such changing operation for the size of the UI screen 60 in the display section 30.

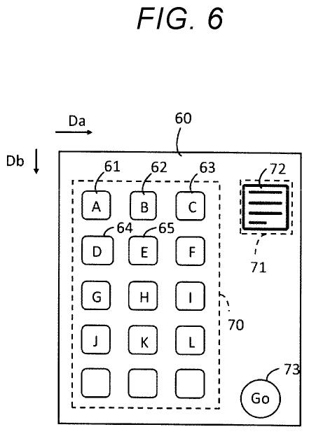

FIG. 6 shows an example of the UI screen 60 in a state different front FIGS. 2A, 2B, 5A, and 5B. Concerning FIG. 6, explanation is omitted about matters common to FIGS. 2A, 2B, 5A, and 5B. The UI screen 60 shown in FIG. 6 shows a state after the changing operation to the longitudinally long size is performed for the UI screen 60 shown in FIG. 2A having the laterally long size. As it is seen from the comparison of FIG. 2A and FIG. 6, the display position of each of the setting buttons changes according to the changing operation for the size. As a result, the distance to the notification display position 71 is changed for each of the setting buttons.

When FIG. 2A and FIG. 6 are compared, for example, the setting button 64 is farther away from the notification display position 71 in the display position in FIG. 6 than in the display position in FIG. 2A. Therefore, the distance between the display position of the setting button 64 and the notification display position 71 in FIG. 6 and the distance between the display position of the setting button 64 and the notification display position 71 in FIG. 2A correspond to the set of the first distance and the second distance. Based on the above explanation, when the setting button 64 is operated in the state shown in FIG. 6, the display control section 23 displays the setting image 72 corresponding to the setting button 64 in a more conspicuous form than when the setting button 64 is operated in the state shown in FIG. 2A.

As it is seen from the above explanation, the display control section 23 causes the display section 30 to display the UI screen 60 on which the plurality of setting buttons are disposed side by side. The plurality of setting buttons include at least a first button and a second button as the setting buttons. Naturally, the plurality of setting buttons may be three or more buttons.

Several specific examples of relationship among the first button, the second button, and the setting image 72 are explained.

The first button may be a button for setting the same function as a function set by the second button and may be a button for applying a setting value larger than a setting value applied by the second button. The first button may be displayed in a position where the distance from the display position of the setting image 72 is longer than the distance of the second button. It is assumed that the first button and the second button are buttons for setting the same function when, for example, both of the first and second buttons are buttons for setting an enlargement/reduction ratio of printing (printing magnification) or buttons for setting the number of prints.

The UI screen 60 shown in FIG. 2A is assumed to be a UI screen for setting functions of the printing section 41. Both of the setting button 61 marked “A” and the setting button 62 marked “B” are assumed to be buttons for setting printing magnification by the printing section 41. More specifically, the setting button 61 is assumed to be a button for setting a value of the printing magnification to 150%. The setting button 62 is assumed to be a button for setting the value of the printing magnification to 120%. That is, since the setting button 61 is a button for applying, as the printing magnification, a setting value larger than a setting value applied by the setting button 62. Therefore, the setting button 61 corresponds to the first button and the setting button 62 corresponds to the second button.

According to the example shown in FIG. 2A, the setting button 61 is displayed in a position at a longer distance from the notification display position 71 than the setting button 62. In this way, the display control section 23 may display the setting buttons for setting the same function such that a button for applying a larger setting value is displayed in a position farther from the setting image 72.

An example of a positional relation among the first button, the second button, and the setting image 72 may be a positional relation in which the first button, the second button, and the setting image 72 are arranged in order in the first direction and the distance between the display position of the first button and the display position of the second button in the first direction is shorter than the distance between the display position of the second button and the notification display position 71 in the first direction. Referring to FIG. 2A, as in the example explained above, the setting button 61 is grasped as the first button and the setting button 62 is grasped as the second button. In this case, a configuration example is considered to be disclosed in which the first button, the second button, and the setting image 72 are arranged in order in the lateral direction Da and the distance between the display position of the first button and the display position of the second button in the lateral direction Da is shorter than the distance between the display position of the second button and the notification display position 71 in the lateral direction Da.

Another example of a positional relation among the first button, the second button, and the setting image 72 may be a positional relation in which the first button or the second button and the setting image 72 are arranged in the first direction and the first button and the second button are arranged in the second direction orthogonal to the first direction. For example, referring to FIG. 2A, the setting button 61 is grasped as the first button and the setting button 65 marked “E” is grasped as the second button. In this case, a configuration example is considered to be disclosed in which the first button and the setting image 72 are arranged in the lateral direction Da, the second button and the setting image 72 are also arranged in the lateral direction Da, and the first button and the second button are arranged in the longitudinal direction db orthogonal to the lateral direction Da.

As explained above, the lateral direction Da may be grasped as the first direction and the longitudinal direction db may be grasped as the second direction. However, the longitudinal direction db may be grasped as the first direction, the lateral direction Da may be grasped as the second direction, and the setting buttons and the setting image 72 may be disposed on the UI screen 60.

### 3. Second Embodiment

A second embodiment is explained. Concerning the second embodiment, explanation is omitted as appropriate about contents common to the first embodiment.

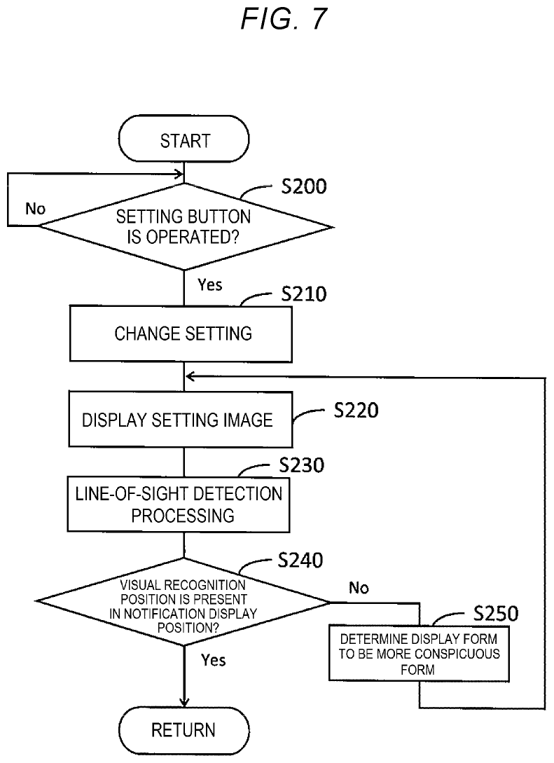

FIG. 7 shows display control processing according to the second embodiment as a flowchart. The processor 21 executes the flowchart in a situation in which the processor 21 is causing the display section 30 to display the UI screen 60. Steps S200 and S210 are the same as steps S100 and S110 in FIG. 3.

Subsequently to step S210, in step S220, the display control section 23 causes the display section 30 to display the setting image 72, which is notification to the effect that a function corresponding to the operated setting button is set, in the notification display position 71 of the UI screen 60. As explained in the first embodiment, the setting image 72 is display involving some change for attracting attention of a user.

In step S230, the detecting section 25 detects a visual recognition position of the user in the display section 30. Step S230 is referred to as line-of-sight detection processing. As the line-of-sight detection processing, various techniques including publicly-known techniques can be adopted. The detecting section 25 in this embodiment acquires, from a camera 80, an image of the user operating the display section 30 captured by the camera 80. The camera 80 is provided in, for example, the display section 30 of a smartphone or a tablet terminal or near the display section 30. The camera 80 is provided in the display section 30 functioning as a display of a PC or near the display section 30. It is assumed that, when the display section 30 is a part of one device 10, the camera 80 is provided near the display section 30.

The detecting section 25 analyzes the image acquired from the camera 80 and detects feature points serving as reference points and moving points such as inner corners of eyes, outer corners of eyes, pupils, and irises of the user to estimate directions of the left and right eyes of the user. The detecting section 25 detects, from a result of the estimation, a position in the display section 30 to which the line of sight of the user is directed, that is, a visual recognition position.

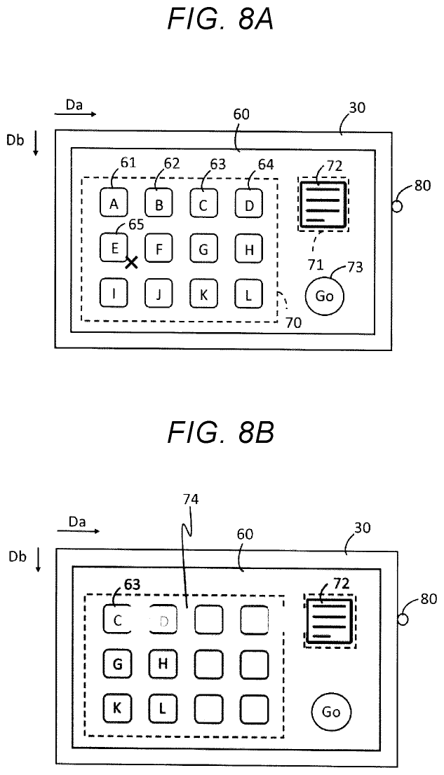

FIG. 8A illustrates a positional relation between the display section 30 and the camera 80. As explained above, the UI screen 60 is displayed on the display section 30. In an example shown in FIG. 8A, the camera 80 is provided in the display section 30 or near the display section 30 in a position closer to the notification display position 71 than display positions of the setting buttons. In FIG. 8A, x mark in the UI screen 60 indicates the visual recognition position of the user. In the example shown in FIG. 8A, the user visually recognizes the vicinity of the setting button 65.

In step S240, the detecting section 25 determines whether the visual recognition position detected in step S230 is present in the notification display position 71. That is, the detecting section 25 determines whether the user is viewing the setting image 72. If the visual recognition position is within a range of the notification display position 71, the detecting section 25 determines that the visual recognition position is present in the notification display position 71 (“Yes” in step S240) and ends the flowchart of FIG. 7. On the other hand, if the visual recognition position is not within the range of the notification display position 71, the detecting section 25 determines that the visual recognition position is absent in the notification display position 71 (“No” in step S240) and proceeds to step S250. The processor 21 only has to repeatedly execute the flowchart of FIG. 7 until the operation start button 73 is operated in a situation in which the processor 21 is causing the display section 30 to display the UI screen 60.

The user operating the UI screen 60 frequently moves the face and the line of sight. Therefore, the detecting section 25 only has to continuously execute the detection in step S230 and the determination in step S240 for, for example, several seconds and, when the visual recognition position stays in the notification display position 71 for a predetermined time (for example, several hundred milliseconds) or more in the several seconds, determine that the visual recognition position is present in the notification display position 71.

In step S250, the display control section 23 compares a display form of the setting image 72 with a display form in nearest step S220 and determines the display form of the setting image 72 to be a more conspicuous form.

The display control section 23 executes step S220 and subsequent steps again through step S250. In step S220 executed through step S250, the display control section 23 causes the display section 30 to display the setting image 72 corresponding to the operated setting button in the notification display position 71 of the UI screen 60 in the display form determined in step S250.

For example, after displaying the setting image 72 shown in FIG. 4A in the notification display position 71 in first step S220, the display control section 23 executes second step S220 through “No” in step S240 and step S250. In this case, in second step S220, the display control section 23 only has to set a size of the image 72b larger than the image 72b in the setting image 72 displayed in first step S220 and cause the display section 30 to display the setting image 72. That is, when the detecting section 25 does not detect that the visual recognition position is present in the notification display position 71, the display control section 23 causes the display section 30 to display the setting image 72 in a more conspicuous form than when the detecting section 25 detects that the visual recognition position is present in the notification display position 71.

### 4. Overview

As explained above, according to the first embodiment, the display control device 20 that causes the display section 30 to display buttons for setting functions of a device (setting buttons) includes the display control section 23 that causes, according to operation of a setting button, the display section 30 to display notification to the effect that a function corresponding to the operated setting button is set and the execution control section 24 that causes the device to execute the function corresponding to the operated setting button. When the distance between a display position of the operated setting button and a display position of the notification is the first distance, the display control section 23 displays the notification in a more conspicuous form than when the distance between the display position of the operated setting button and the display position of the notification is the second distance shorter than the first distance.

With the configuration, when the distance between the setting button operated by the user and the display position of the notification is long, the notification is displayed in the more conspicuous form. Therefore, the user can easily notice the notification and appropriately understand setting by the operation by the user. When the distance between the setting button operated by the user and the display position of the notification is short, the notification is displayed at a relatively reduced degree of conspicuousness. Therefore, it is possible to prevent the user from feeling unpleasant.

The display control section 23 changes the distance between a display position of each of the setting buttons and the display position of the notification according to predetermined operation and differentiates the display form of the notification according to the distance between the display position of the operated setting button and the display position of the notification.

Specifically, the display control section 23 changes the distance between the display position of each of the setting buttons and the display position of the notification according to scrolling operation for a region where the plurality of setting buttons are displayed side by side in the display section 30.

Further, the display control section 23 changes the distance between the display position of each of the setting buttons and the display position of the notification according to display mode changing operation for changing the number of setting buttons displayed on the display section 30 at a time.

Further, the display control section 23 changes the distance between the display position of each of the setting buttons and the display position of the notification according to customizing operation for selecting a setting button to be displayed on the display section 30.

Further, the display control section 23 changes the distance between the display position of each of the setting buttons and the display position of the notification according to changing operation for a screen size in the display section 30.

With these configurations, even in a situation in which the display control section 23 changes the display positions of the setting buttons according to predetermined operation by the user, by measuring the distance between the display position of the operated setting button and the display position of the notification, the display control section 23 can display the notification in an appropriate display form corresponding to the distance between the operated setting button and the notification every time the display positions are changed.

According to this embodiment, the display control section 23 is capable of causing the display section 30 to display three or more setting buttons. The display control section 23 causes the display section 30 to display the notification in a more conspicuous form when the setting button farther from the display position of the notification is operated.

However, the display control section 23 may set, about the setting buttons having a certain degree of a similar relation of a distance to the notification in the display section 30, the display form of the notification at operation times of the setting buttons to the same conspicuousness degree. That is, the display control section 23 classifies the plurality of setting buttons into, for example, approximately three groups according to the distances from the notification display position 71. The display control section 23 causes a difference in a conspicuousness degree of the display form of the notification at the operation time of the setting buttons among different groups and does not cause a difference in the conspicuousness degree among the setting buttons in the same group.

According to this embodiment, the display control section 23 causes the display section 30 to display the plurality of setting buttons including the first button and the second button.

The first button may be a setting button for setting the same function as the function set by the second button and a setting button for applying a setting value larger than a setting value applied by the second button. The first button may be displayed in a position farther from the display position of the notification than the second button.

With the configuration explained above, relationship in terms of functions between the first button and the second button and senses of distances between the first button and the second button and the notification visually coincide. It is possible to provide a UI screen easy to operate to the user.

According to this embodiment, the display control section 23 can adopt disposition in which the first button, the second button, and the notification are arranged in order in the first direction and the distance between the display position of the first button in the first direction and the display position of the second button is set shorter than the distance between the display position of the second button and the display position of the notification in the first direction.

According to this embodiment, the display control section 23 can adopt disposition in which the first button or the second button and the notification are arranged in the first direction and the first button and the second button are arranged in the second direction orthogonal to the first direction.

According to the second embodiment, the display control device 20 that causes the display section 30 to display buttons for setting functions of a device (setting buttons) includes the display control section 23 that causes, according to operation of a setting button, the display section 30 to display notification to the effect that a function corresponding to the operated setting button is set, the detecting section 25 that detects a visual recognition position of the user in the display section 30, and the execution control section 24 that causes the device to execute the function corresponding to the operated setting button. When the detecting section 25 does not detect that the visual recognition position is present in the display position of the notification, the display control section 23 causes the display section 30 to display the notification in a more conspicuous form than when the detecting section 25 detects that the visual recognition position is present in the display position of the notification.

With the configuration explained above, when the user is viewing the operated setting button or the vicinity of the operated setting button and is not viewing the notification, the notification is displayed in a more conspicuous form. Therefore, the user can easily notice the notification and appropriately understand setting by the operation by the user. When the user is viewing the notification, the notification is displayed with a relatively reduced conspicuousness degree. Therefor, it is possible to prevent the user from feeling unpleasant.

When the visual recognition position continuously stays in the display position of the notification for a predetermined time or more, the detecting section 25 may detect that the visual recognition position is present in the display position of the notification.

With the configuration, it is possible to accurately detect whether the user views the notification.

The display control device 20 includes the camera 80 in the display section 30 or near the display section 30 in a position closer to the display position of the notification than the display positions of the setting buttons. The detecting section 25 detects a visual recognition position based on an image of the user captured by the camera 80.

With the configuration explained above, by using the image from the camera 80 provided in the position close to the display position of the notification for the detection of the visual recognition position of the user, the detecting section 25 can highly accurately detect whether the visual recognition position is present in the display position of the notification.

However, the position of the camera 80 is not limited to the position shown in FIG. 8A. A camera generally provided in a smartphone, a tablet terminal, or a PC can be used as means for acquiring a user image. The number of cameras is not limited to one and may be plural.

This embodiment discloses inventions of a method and a program other than inventions of objects such as the display control device 20, the system (the device) 10, and the display device 50.

That is, according to the first embodiment, a display control program for causing the processor 21 to execute processing for displaying, on the display section 30, a setting button for setting a function of a device includes a display control function for causing, according to operation of the setting button, the display section 30 to display notification to the effect that the function corresponding to the operated setting button is set and an execution control function for causing the device to execute the function corresponding to the operated setting button. When a distance between a display position of the operated setting button and a display position of the notification is a first distance, the display control function causes the display section 30 to display the notification in a more conspicuous form than when the distance between the display position of the operated setting button and the display position of the notification is a second distance shorter than the first distance.

According to the second embodiment, a display control program for causing the processor 21 to execute processing for displaying, on the display section 30, a setting button for setting a function of a device includes a display control function, an execution control function, and a detecting function for detecting a visual recognition position of a user in the display section 30. When the detecting function does not detect that the visual recognition position is present in a display position of notification, the display control function causes the display section 30 to display the notification in a more conspicuous form than when the detecting function detects that the visual recognition position is present in the display position of the notification.

### 5. Other Embodiments

FIG. 8B shows the UI screen 60 including a guidance display 74. The display control section 23 may perform, on the UI screen 60, in a path connecting a setting button operated by a user and the notification display position 71, the guidance display 74 for guiding a line of sight of the user to the setting image 72. In an example shown in FIG. 8B, the guidance display 74 is performed in a path connecting the setting button 63 operated by the user and the notification display position 71. When the user operates a setting button, the display control section 23 performs the guidance display 74 by light by, for example, reducing brightness of the UI screen 60 as a whole and increasing brightness of a path connecting the setting button operated by the user and the notification display position 71.

In the first embodiment, as the distance between the setting button operated by the user and the notification display position 71 is longer, the display control section 23 only has to set a display form of the guidance display 74 to a more conspicuous form by, for example, improving brightness of the guidance display 74. In the second embodiment, when the visual recognition position of the user is absent in the notification display position 71, the display control section 23 only has to set the display form of the guidance display 74 to a more conspicuous form. As shown in FIG. 8B, when the guidance display 74 by light is performed, the display control section 23 may increase brightness of the setting button operated by the user and the setting image 72 to make the setting button operated by the user and the setting image 72 conspicuous. Naturally, a specific method of the guidance display 74 is not limited to the guidance by light. For example, an arrow directed from the setting button operated by the user to the notification display position 71 may be displayed.

A combination of the first embodiment and the second embodiment is also within a disclosed range of the embodiments.

When determining “Yes” in step S200 in FIG. 7 in the second embodiment and displaying the setting image 72 through step S210, the display control section 23 may execute steps S120, S130, and S140 as in the first embodiment instead of step S220.

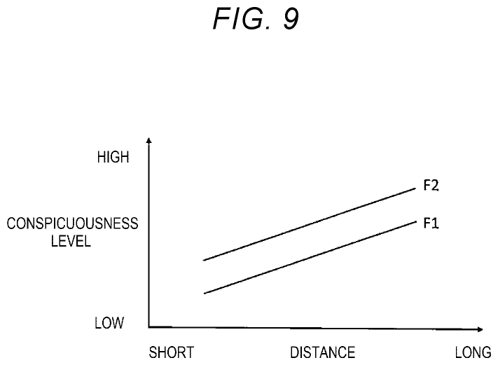

FIG. 9 shows a correspondence relation between a distance and a conspicuousness level. The distance is the distance between the display position of the setting button operated by the user and the notification display position 71. The conspicuousness level is a degree of conspicuousness in displaying the setting image 72 corresponding to the operated setting button. The conspicuousness level is increased in proportion to the distance in both of correspondence relations F1 and F2. The correspondence relations F1 and F2 are respectively functions or tables.

In a state in which the UI screen 60 is displayed, when displaying the setting image 72 first according to operation of any setting button by the user, the display control section 23 determines a conspicuousness level corresponding to a distance referring to the correspondence relation F1 in step S130 and displays the setting image 72 in step S140 in a display form of the determined conspicuousness level. Subsequently to step S140, the detecting section 25 executes steps S230 and S240. If it is determined “No” in step S240, the display control section 23 executes step S250. In step S250, the display control section 23 determines a conspicuousness level corresponding to a distance referring to the correspondence relation F2 and displays the setting image 72 in second or subsequent step S220 in a display form of the determined conspicuousness level.

As it is seen from FIG. 9, in the correspondence relation F2, the conspicuousness level corresponding to the distance is determined to be a level higher than the conspicuousness level in the correspondence relation F1. With such a configuration, when the display control section 23 displays, in response to operation of a setting button, the setting image 72 in the display form of the conspicuousness level corresponding to the distance based on the correspondence relation F1, if the user is not viewing the setting image 72, the display control section 23 can further increase the conspicuousness level corresponding to the distance based on the correspondence relation F2 and make the setting image 72 more conspicuous and display the setting image 72.

The “notification” in this embodiment may be, besides the setting image 72 by an illustration, an icon, an animation, or the like, a message by a character string for informing the user that the function corresponding to the operated setting button is set. The display control section 23 can attract attention of the user to the message by increasing the size of the message, moving the message, changing a color of the message, emitting light from the message, flashing the message, or applying some decoration to the message. The display control section 23 only has to differentiate a display form, that is, a conspicuousness degree of such a message according to the distance between the operated setting button and the notification display position 71 or the visual recognition position of the user. The operation by the user is not limited to touch operation performed using the touch panel. For example, the user moving a displayed cursor and clicking a displayed button using a mouse is considered to be operation on the button in the position of the button. The user moving a displayed cursor and performing gesture operation using a mouse is also considered to be the operation by the user. The display of the button and the notification is not limited to display on one liquid crystal display. For example, the button and the notification may be displayed on separate liquid crystal displays. Further, at least parts of the button and the notification may be displayed by being projected to a wall surface, the air, or the like or may be displayed by an LED.

What is claimed is:

1. A display control device that causes a display section to display a button for setting a function of a device, the display control device comprising:
a display control section configured to cause, according to operation of the button, the display section to display notification to the effect that the function corresponding to the operated button is set; and
an execution control section configured to cause the device to execute the function corresponding to the operated button, wherein
when a distance between a display position of the operated button and a display position of the notification is a first distance, the display control section causes the display section to display the notification in a more conspicuous form than when the distance between the display position of the operated button and the display position of the notification is a second distance shorter than the first distance.

2. The display control device according to claim 1, wherein the display control section changes a distance between a display position of each the button and the display position of the notification according to predetermined operation and differentiates a display form of the notification according to the distance between the display position of the operated button and the display position of the notification.

3. The display control device according to claim 2, wherein the display control section changes the distance between the display position of each the button and the display position of the notification according to scrolling operation for a region where a plurality of the buttons are displayed side by side in the display section.

4. The display control device according to claim 2, wherein the display control section changes the distance between the display position of each the button and the display position of the notification according to display mode changing operation for changing a number of the buttons displayed on the display section at a time.

5. The display control device according to claim 2, wherein the display control section changes the distance between the display position of each the button and the display position of the notification according to customizing operation for selecting the button displayed on the display section.

6. The display control device according to claim 2, wherein the display control section changes the distance between the display position of each the button and the display position of the notification according to changing operation for a screen size in the display section.

7. The display control device according to claim 1, wherein the display control section causes the display section to display a trio or more of the buttons and causes the display section to display the notification in a more conspicuous form when a button farther from the display position of the notification is operated.

8. The display control device according to claim 1, wherein the display control section causes the display section to display a plurality of buttons including a first button and a second button, and
the first button is a button for setting a same function as a function set by the second button and is a button for applying a setting value larger than a setting value applied by the second button, and the first button is displayed in a position farther from the display position of the notification than the second button.

9. The display control device according to claim 1, wherein
the display control section causes the display section to display a plurality of the buttons including a first button and a second button,
the first button, the second button, and the notification are arranged in order in a first direction, and
a distance between a display position of the first button and a display position of the second button in the first direction is shorter than a distance between the display position of the second button and a display position of the notification in the first direction.

10. The display control device according to claim 1, wherein
the display control section causes the display section to display a plurality of the buttons including a first button and a second button,
the first button or the second button and the notification are arranged in a first direction, and
the first button and the second button are arranged in a second direction orthogonal to the first direction.

11. A non-transitory computer-readable storage medium storing a display control program for causing a processor to execute processing for displaying, on a display section, a button for setting a function of a device, the display control program comprising:
a display control function for causing, according to operation of the button, the display section to display notification to the effect that the function corresponding to the operated button is set; and
an execution control function for causing the device to execute the function corresponding to the operated button, wherein
when a distance between a display position of the operated button and a display position of the notification is a first distance, the display control function causes the display section to display the notification in a more conspicuous form than when the distance between the display position of the operated button and the display position of the notification is a second distance shorter than the first distance.

12. A non-transitory computer-readable storage medium storing a display control program for causing a processor to execute processing for causing a display section to display micro-interaction corresponding to operation by a user, the display control program comprising:
a receiving function for receiving the operation; and
a display control function for causing the display section to display the micro-interaction in a more conspicuous form when a distance between a position where the operation is performed and a display position of the micro-interaction is a first distance than when the distance is a second distance shorter than the first distance.
